(19) United States
(12) Patent Application Publication
(10) Pub. No.: US 2023/0165293 A1
(43) Pub. Date: Jun. 1, 2023

(54) Shelf Stable Food with Protein Binder

(71) Applicant: General Mills, Inc., Minneapolis, MN (US)

(72) Inventors: Colby Darling, Minneapolis, MN (US); Sara Rosene, New Hope, MN (US)

(73) Assignee: General Mills, Inc., Minneapolis, MN (US)

(21) Appl. No.: 17/918,279

(22) PCT Filed: Apr. 15, 2020
(86) PCT No.: PCT/US20/28224

§ 371 Date: Oct. 11, 2022

(51) Int. Cl. A23P 10/20; A23L 11/00; A23L 25/00; A23L 33/19; A23L 5/10

(52) U.S. Cl. CPC A23P 10/20; A23L 11/07; A23L 25/20; A23L 33/19; A23L 5/15

(57) ABSTRACT

A low or no refined sugar, high protein shelf stable food is described. A shelf stable food includes an aggregate component held together with a continuous phase that includes a water soluble protein and a soluble fiber, where the water soluble fiber contributes substantially all binding activity of the continuous phase. Methods of making a shelf stable food are also described.

### BACKGROUND

Consumers are increasingly looking for foods that meet their nutritional needs without requiring preparation. Shelf stable baked snack items are a category of ready-to-eat foods that can be challenging to make fit both nutritional needs and a desired eating experience. Ready-to-eat baked products that contain low or no sugar and high protein content provide a challenge for delivering a desirable taste and texture over the shelf life of the product. Thus, there is a need for good-tasting ready-to-eat products that meet desired nutritional needs and retain a desirable eating experience over shelf life.

### SUMMARY

The present disclosure relates to a shelf stable food with a novel protein binder that has a desirable texture, extended shelf life, and good manufacturability.

A shelf stable food is described. A shelf stable food can include an aggregate phase providing an aggregate component, the aggregate component contributing at least 50% by weight of the shelf stable food, and a continuous phase in an amount of 10% to 50% by weight of the shelf stable food, the continuous having a binding activity that binds the aggregate component together, the continuous phase including a water soluble protein in an amount of from about 8% to about 30% by dry weight of the continuous phase and a soluble fiber in an amount of from about 5% to up to 30% by dry weight of the continuous phase, the water soluble protein contributing substantially all of the binding activity, where the food has a moisture content of about 3% to about 5% and has a crunchy texture upon eating.

In some embodiments, a water soluble protein can include whey protein.

In some embodiments, a continuous phase can further include a sugar alcohol. In some embodiments, a sugar alcohol can include erythritol.

In some embodiments, soluble fiber can be included in an amount of from about 10% to about 25% by dry weight of the continuous phase. In some embodiments, soluble fiber can include inulin.

In some embodiments, an aggregate component can include permeable or semi-permeable particulates in an amount of from about 15% to about 25% by weight of the aggregate component.

In some embodiments, a shelf stable food can include no refined sugar. In some embodiments, a shelf stable food can include less than 5% by total weight sugar.

In some embodiments, a shelf stable food can include at least 25% by weight protein.

In some embodiments, a shelf stable food can have a caloric content that comprises about 10% to about 20% of the caloric content of the shelf stable food from protein, about 60% to about 90% of the caloric content of the shelf stable food from fat, and about 5% to about 15% of the caloric content of the shelf stable food from carbohydrate.

In some embodiments, a shelf stable food can have a water activity of less than 0.5.

A method of making a shelf stable food is also provided. A method of making a shelf stable food can include providing an aggregate phase including an aggregate component and a fat, providing a continuous phase component, the continuous phase component comprising an emulsion including dissolved soluble protein in an amount of about 8% to about 30% by dry weight of the continuous phase component, soluble fiber in an amount of about 5% to up to 30% by dry weight of the continuous phase component, fat in an amount of about 15% to about 25% by dry weight of the continuous phase component, and a moisture content of about 15% to less than 25% by weight of the continuous phase, combining the aggregate phase with the continuous phase component to produce a formable composition, the formable composition including the aggregate component and the continuous phase at a ratio by weight of the aggregate component to the continuous phase component of about 50:50 to 80:20, and baking the formable composition to a moisture level of from about 3% to about 5% to make the shelf stable food, the shelf stable food having a crunchy texture and a continuous phase that includes the soluble protein, the continuous having a binding activity that binds the aggregate component together, the water soluble protein contributing substantially all of the binding activity.

In some embodiments, a method can further include producing a continuous phase component by combining the protein, the fat, and the water under conditions sufficient to produce the emulsion, and allowing the emulsion to rest for at least 5 minutes before combining with the aggregate phase.

In some embodiments, a method can further include producing the aggregate phase by combining the aggregate component with the fat.

In some embodiments, a method can further include allowing the formable composition to rest for at least 5 minutes.

In some embodiments, a method can further include forming the formable composition into pieces before baking.

In some embodiments, a method can further comprising include the formable composition into a sheet or slab, and cutting the sheet or slab into pieces after baking.

In some embodiments of a method provided herein, the shelf stable food can have a caloric content that comprises about 10% to about 20% of the caloric content of the shelf stable food from protein, about 60% to about 90% of the caloric content of the shelf stable food from fat, and about 5% to about 15% of the caloric content of the shelf stable food from carbohydrate.

These and various other features and advantages will be apparent from a reading of the following detailed description.

### BRIEF DESCRIPTION OF DRAWINGS

FIG. 1 is a photograph of a cross section of a shelf stable food according to an embodiment of the described invention that contains low permeability and permeable or semi-permeable aggregate components. The photograph shows low permeability aggregate component (almond pieces and pumpkin seeds) and permeable or semi-permeable aggregate component (soy protein crisps) with a continuous phase adhering the aggregate components together to form a crunchy snack bar.

FIG. 2 is a photograph of a cross section of a shelf stable food according to an embodiment of the described invention that contains low permeability and permeable or semi-permeable aggregate components. The photograph shows low permeability aggregate component (almond pieces and pumpkin seeds) and permeable or semi-permeable aggregate component (soy protein crisps) with a continuous phase adhering the aggregate components together. Some absorption of the continuous phase is visible on the surface of the permeable or semi-permeable aggregate component, but the continuous phase still sufficiently binds the aggregate components together to form a crunchy snack bar. The continuous phase can be found between individual particulates of the aggregate phase. Some air pockets are visible, as well, but most gaps between individual particulates are filled or mostly filled with continuous phase.

FIG. 3 is a photograph of a cross section of a shelf stable food according to an embodiment of the described invention that contains low permeability aggregate component but does not contain permeable or semi-permeable aggregate component. The photograph shows low permeability aggregate component (almond pieces and pumpkin seeds) with a continuous phase adhering the aggregate components together to form a crunchy snack bar. The continuous phase can be found between individual particulates of the aggregate phase. Some air pockets are visible, as well, but most gaps between individual particulates are filled or mostly filled with continuous phase.

FIG. 4 is a photograph of a cross section of a food that contains permeable or semi-permeable aggregate component but does not contain low permeability aggregate component. The photograph shows low permeability aggregate component (almond pieces and pumpkin seeds) and permeable or semi-permeable aggregate component (soy protein crisps) with a continuous phase adhering the aggregate components together to form a crunchy snack bar. The continuous phase can be found between individual particulates of the aggregate phase, but much of the continuous phase is absorbed into the surface of the permeable or semi-permeable aggregate component particulates. Many air pockets are visible, with very few gaps between individual particulates filled or mostly filled with continuous phase. The crunchy bar in this figure does not sufficiently adhere, and crumbles easily.

FIG. 5 is a photograph of the surfaces of each of the foods shown in FIGS. 2-4. Gaps between individual particulates of the food that contains only permeable or semi-permeable aggregate component are readily visible.

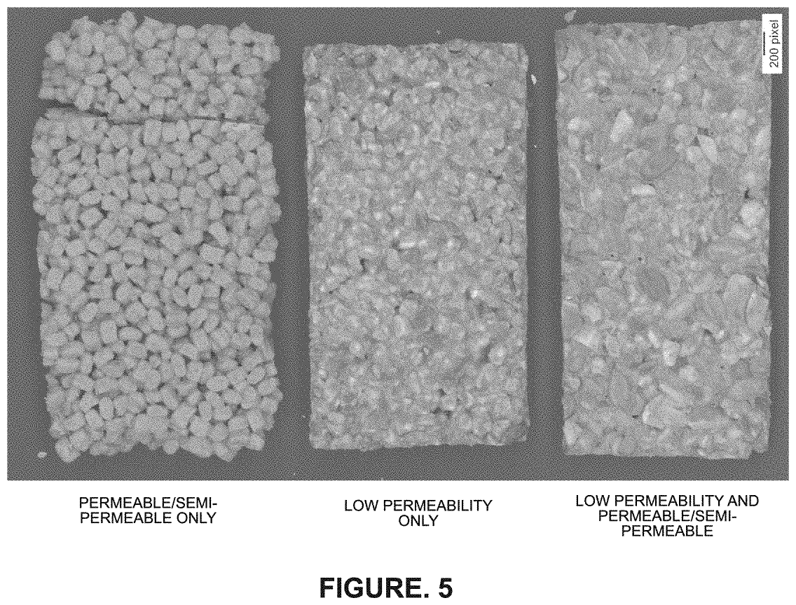

FIG. 6 is a micrograph of a continuous phase component showing cinnamon particulates and undissolved erythritol crystals. Whey protein appears to be completely dissolved in this continuous phase component.

FIG. 7 is an illustration of outcomes of a food slump test described in Example 1. FIG. 7A illustrates slump of a formable composition, with the dotted line showing the shape of the food slump test mold. FIG. 7B illustrates no slump of a formable composition. FIG. 7C illustrates collapse of a formable composition, with the dotted line showing the shape of the food slump test mold.

### DETAILED DESCRIPTION

Consumers often look for convenient foods that fit a desired nutritional profile. Foods that have no refined sugar and/or a particular ratio of protein to fat to net carbohydrate content fit one such nutritional profile. Achieving no refined sugar content is a particular challenge for crunchy snack bars because sugar not only provides sweetness, but also plays a significant role in binding particulates together and providing a crunchy, glassy binder texture. As a result, reducing or removing sugar content in a crunchy snack bar binder, particularly sucrose content, can negatively impact flavor, texture, and overall functionality. Although at least some of the sweetness of sugar can be replaced by using non-sugar sweeteners, such as sugar alcohols (e.g., erythritol, maltitol, and the like) and high intensity sweeteners (e.g., sucralose, stevia extract, and the like), non-sugar sweeteners fail to provide texture and function of a sugar-based binder. Commercially available snack foods that use a fat and/or protein-based binder to bind particulates together have a soft, chewy texture, rather than a crunchy texture resembling a glassy, sugar-based binder, or include gums and/or sugar to achieve a crunchy texture.

It was discovered, and is disclosed herein, that a protein-based binder can be used to bind an aggregate component together resulting in a shelf stable food with a crunchy texture without including refined sugar in a binder. The disclosed shelf stable foods uniquely have a large volume of aggregate component relative to binder and a crunchy texture.

As used herein the term “refined sugar” refers to sugars, other than allulose, that are extracted or purified from their original source. Examples of refined sugar include table sugar (sucrose), honey, syrups (e.g., maple syrup, corn syrup, tapioca syrup, malt syrup, and the like), molasses, purified dextrose, and the like. In some embodiments, a shelf stable food provided herein can contain no refined sugar. A shelf stable food provided herein can include sugars in amounts that are naturally present in ingredients, such as nuts, whole grains, and dried fruit, or are incidentally included in minor amounts in ingredients such as vanilla extract or soluble fiber.

A shelf stable food provided herein includes an aggregate phase including an aggregate component. In some embodiments, an aggregate phase contributes an aggregate component to a shelf stable food in an amount of at least 50% (e.g., at least 60%, at least 70%, or from about 75% to about 90%) by volume of the shelf stable food. In some embodiments, an aggregate phase is included in a shelf stable food in an amount of at least 50% (e.g., at least 60%, or from about 70% to about 85%) by weight of the shelf stable food. It is to be understood that the amount of aggregate component can vary based on the specific density of the aggregate component.

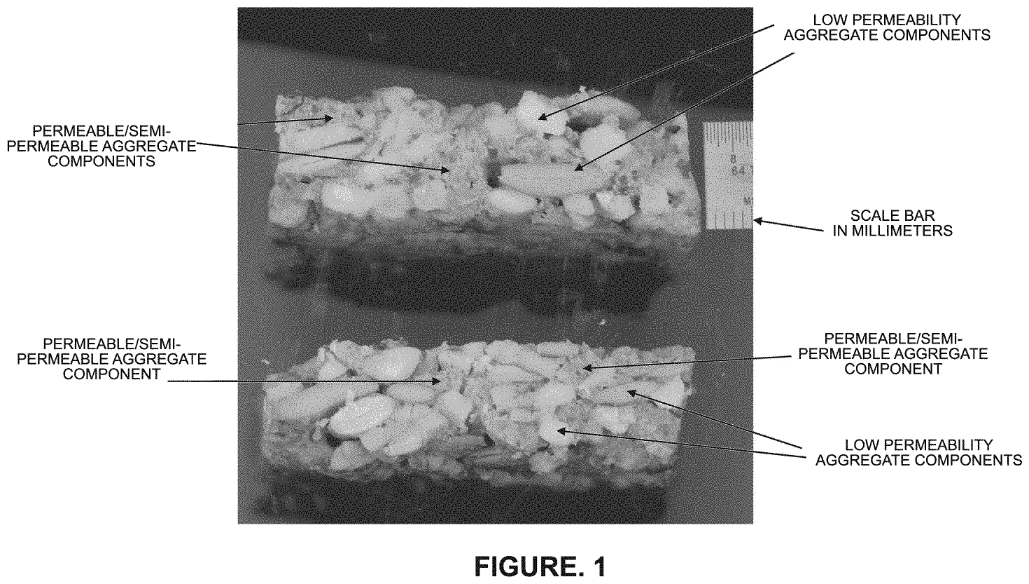

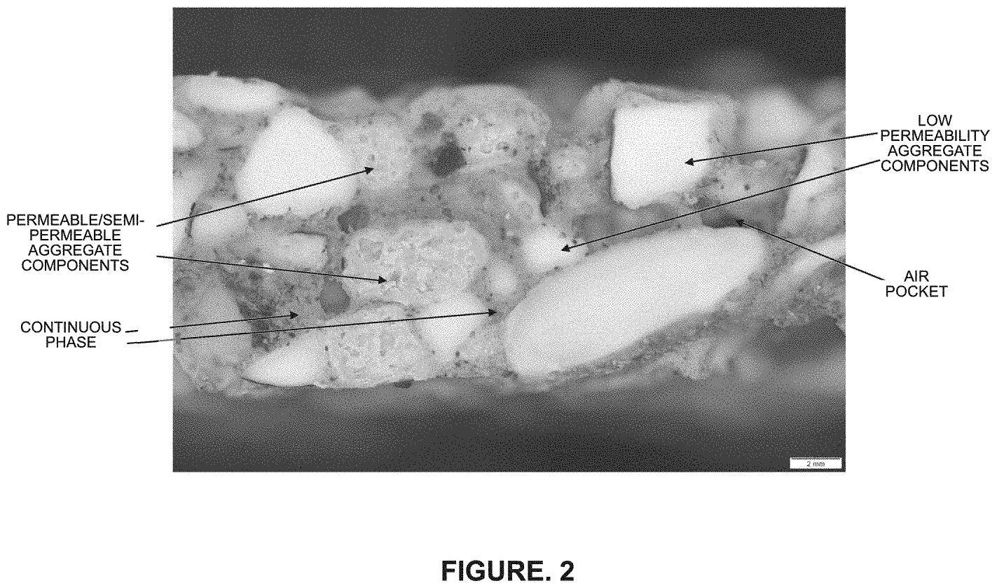

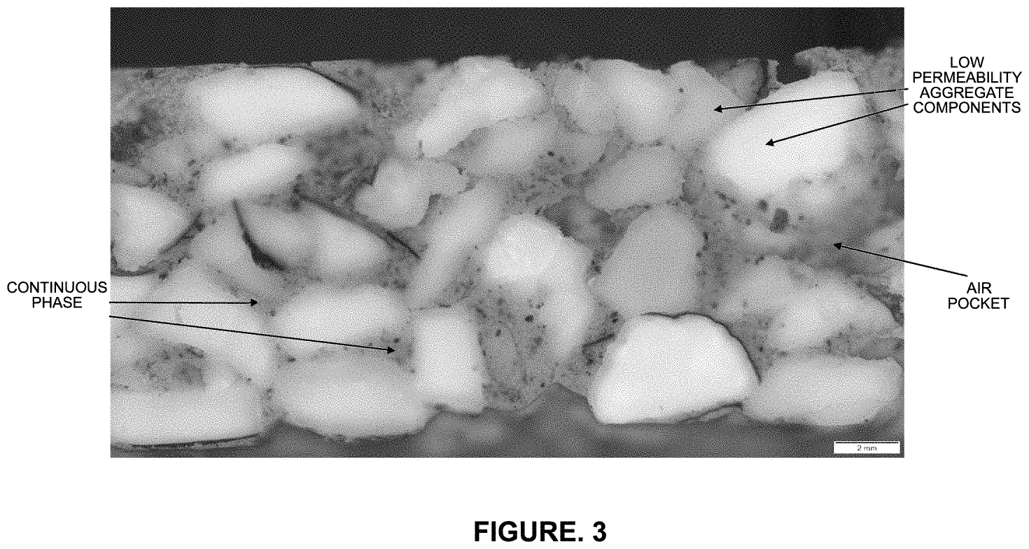

As used herein, volume of aggregate component or a continuous phase in a shelf stable food can be estimated based on cross sectional images of the shelf stable food. See, FIGS. 1-3.

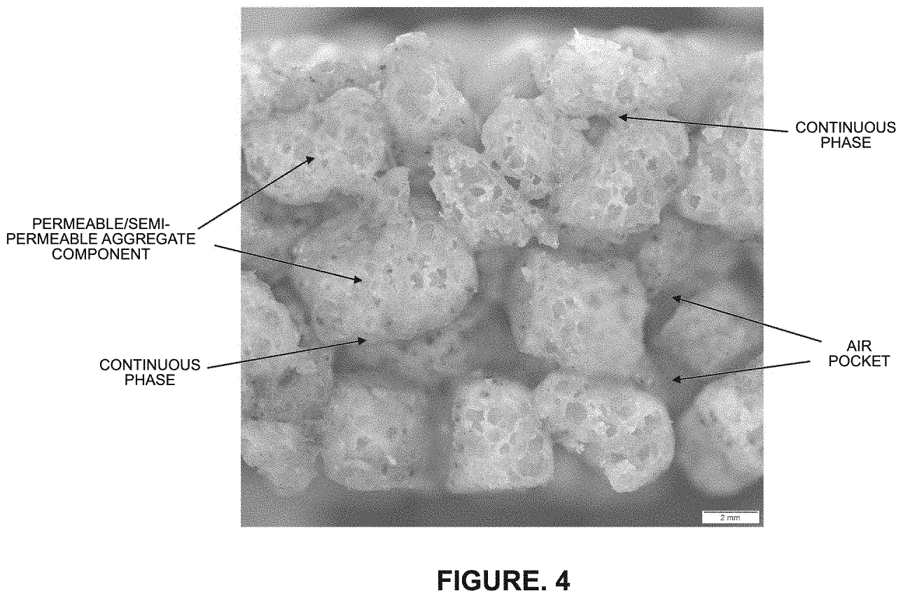

As used herein, the term “aggregate component” refers to a plurality of edible particulates. At least a portion of an aggregate component comprises particulates with low permeability (e.g., nut and nut pieces, seeds, and the like). See, FIGS. 1-3. In some embodiments, a portion of an aggregate component can include permeable or semi-permeable particulates (e.g., protein crisps, grain puffs, rolled oats, coconut pieces, and the like). In some embodiments, permeable or semi-permeable particulates can be included in an aggregate component in an amount of up to 30% (e.g., up to 25%, up to 20%, or from about 10% to about 20%) by weight of the plurality of edible particulates in an aggregate component. In some embodiments, permeable or semi-permeable particulates can be included in an aggregate component in an amount of up to 50% (e.g., up to 40%, up to 30%, or from about 15% to about 25%) by volume of the plurality of edible particulates in an aggregate component. See, FIGS. 1, 2, and 4.

In some embodiments, at least 50% (e.g., at least 60%, or at least 80%) by weight of the plurality of edible particulates in an aggregate component can be sized such that they are retained on a 2 mm opening on a sieve (e.g., No. 8 mesh sieve). In some embodiments, at least a portion (e.g., at least 20%, at least 25%, at least 30% by weight) of the plurality of edible particulates in an aggregate component can be sized such that they are retained on a 4 mm opening on a sieve (e.g., No. 5 mesh sieve). In some embodiments, at least a portion (e.g., at least 10%, at least 15%, or at least 20% by weight) of the plurality of edible particulates in an aggregate component can be sized such that they are retained on a 6.35 mm opening on a sieve (e.g., ¼ inch mesh sieve, or a 16/64 round hole sieve).

In some embodiments, an aggregate component can be formulated to achieve a desired nutritional profile. For example, an aggregate component can be formulated to have a high protein content by including nuts and/or protein crisps.

In some embodiments, an aggregate phase can include an added fat in an amount of up to 20% (e.g., up to 15%, or up to 10%) by weight of the aggregate phase. As used herein “added fat” with reference to an aggregate phase refers to a fat added to the aggregate component of the aggregate phase. An added fat does not refer to fat natively found in particulates (e.g., nuts or seeds) in an aggregate component in an aggregate phase. Any edible fat, including liquid oil (e.g., soy oil, canola oil, avocado oil, algae oil, and the like) and solid fat (e.g., coconut oil, palm oil, palm kernel oil, shortening, lard, and the like), or any combination thereof, can be included in an aggregate phase. Although not essential to development of a desired shelf stable food with a crunchy texture, a fat in an aggregate phase can contribute to improved texture of permeable or semi-permeable particulates in the shelf stable food. Without being bound by theory, it is believed that a fat in an aggregate phase can coat a surface of permeable or semi-permeable particulates in an aggregate component and reduce absorption of a protein-based binder described herein before baking. As a result, permeable or semi-permeable particulates can be perceived to be more crispy in a resulting shelf stable food.

A shelf stable food provided herein includes a continuous phase that binds an aggregate component together and contributes to a crunchy texture of the shelf stable food that has a moisture content of about 3% to about 5%. In some embodiments, a continuous phase of a shelf stable food can be included in the shelf stable food in an amount of about 10% to about 50% (e.g., about 15% to about 30%, or about 15% to about 25%) by weight of the shelf stable food. In some embodiments, a continuous phase of a shelf stable food can be included in the shelf stable food in an amount of about 10% to about 50% (e.g., about 15% to about 30%, or about 15% to about 25%) by volume of the shelf stable food. See, FIGS. 1-3.

A continuous phase in a shelf stable food includes a water soluble protein in an amount of from about 8% to about 30% (e.g., about 10% to about 25%, or about 12% to about 20%) by dry weight of the continuous phase. As used herein, a water soluble protein is substantially soluble in water at 50° C. Examples of suitable water soluble proteins include, for example, whey protein, egg protein, zein, gelatin, collagen, and some soy proteins. Whey protein is particularly useful due to its desirable flavor attributes and high solubility.

A continuous phase of a shelf stable food provided herein includes a soluble fiber in an amount of from about 5% to up to 30% (e.g., from about 5% to about 15%, or from about 7% to about 12%) by dry weight of the continuous phase. Any soluble fiber can be included in a continuous phase including, without limitation, inulin, soluble corn fiber, beta glucan, polydextrose, and the like, or any combination thereof.

In some embodiments, a continuous phase includes a sugar alcohol in an amount of up to 60% (e.g., up to 50%, or from about 30% to about 45%) by dry weight. Suitable sugar alcohols include sugar alcohols that have a solubility of less than 70 g/100 ml water at 25° C., such as erythritol and mannitol. A sugar alcohol in a continuous phase is preferably in crystal form. Erythritol is particularly suitable due to its flavor profile and inability to induce a glucose response in humans.

A continuous phase of a shelf stable food provided herein can include a fat in an amount of up to 30% (e.g., up to 25%, or from about 15% to about 25%) by dry weight of the continuous phase. Any edible fat, including liquid oil (e.g., soy oil, canola oil, avocado oil, algae oil, and the like) and solid fat (e.g., coconut oil, palm oil, palm kernel oil, shortening, lard, and the like), or any combination thereof, can be included in a continuous phase. In some embodiments, a solid fat can be preferred for inclusion in a continuous phase to contribute to setting of the continuous phase during manufacture. A fat in a continuous phase of a shelf stable food can be the same or different than a fat in an aggregate phase of the shelf stable food. In some embodiments, an amount and/or type of fat in a shelf stable food, including fat in the aggregate phase and fat in the continuous phase, can be selected based on the desired nutritional profile of the shelf stable food. For example, a higher amount of fat can be selected to provide a nutritional profile suitable for a ketogenic diet.

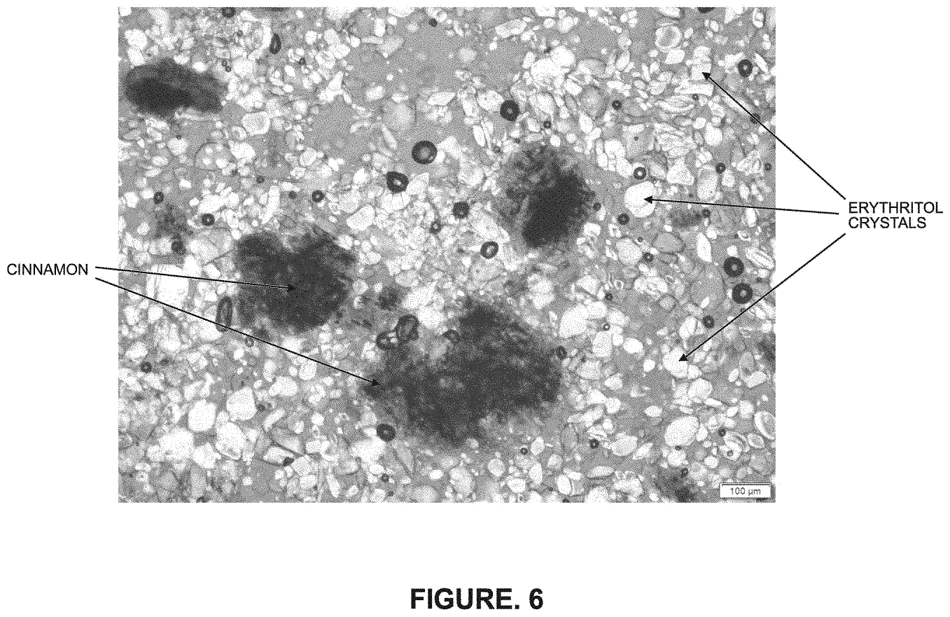

Surprisingly, a water soluble protein in a continuous phase contributes substantially all of the binding activity in a continuous phase to produce a crunchy texture in a shelf stable food describe herein. It has been observed that, although other ingredients have potential for binding activity in a continuous phase described herein, such as sugar alcohol and soluble fiber, they do not appear to contribute to binding. As described in Example 2 and shown in FIG. 6, when erythritol is included in a continuous phase, it remains in crystalline form rather than dissolving in the continuous phase, and does not bind an aggregate component together. It has also been observed that binding activity of a continuous phase is not significantly affected if a soluble fiber is not included in the continuous phase. In addition, a shelf stable food provided herein can also contain substantially no gums (e.g., xanthan gum, gum Arabic/gum acacia, cellulose gum, pectin, methylcellulose, and the like) in a continuous phase, which might contribute to binding. It is also surprising that a water soluble protein can be included in a continuous phase in an amount of about 8% to about 30% by dry weight of the continuous phase and still bind an aggregate component together in the presence of a relatively larger amount of other ingredients (70% to 92% by dry weight of the binder).

In some embodiments, additional ingredients can be included in a shelf stable food provided herein. For example, a high intensity sweetener (e.g., stevia extract, monkfruit extract, sucralose, and the like, or any combination thereof), allulose, a flavorant (e.g., spices, extracts, salt, cocoa powder, and the like, or any combination thereof), emulsifiers, colorants, and the like can be included in a shelf stable food. Additional ingredients can be included in either an aggregate phase or a continuous phase of a shelf stable food. Preferably, additional ingredients are included in a continuous phase of a shelf stable food to ensure that they are sufficiently distributed throughout the food. Additional ingredients can be included in a food in an amount of up to 15% (e.g., up to 10%) by dry weight of a shelf stable food provided herein.

In some embodiments, a shelf stable food provided herein can have a protein content of at least 20% (e.g., at least 22%, at least 25%, or from about 27% to about 35%) by weight of the shelf stable food. Protein content in a shelf stable food can be contributed by a soluble protein in a continuous phase, as well as from an aggregate component (e.g., protein from nuts, seeds, protein crisps, and the like).

In some embodiments, a shelf stable food provided herein can have a fat content of at least 20% (e.g., at least 25%, at least 35%, or from about 40% to about 60%) by weight of the shelf stable food. Fat content in a shelf stable food can be contributed by a fat in a continuous phase, a fat combined with an aggregate component in an aggregate phase, and/or fat in an aggregate component (e.g., fat from nuts, seeds, and the like).

In some embodiments, a shelf stable food provided herein can have a total carbohydrate content of less than 50% (e.g., less than 30%, or less than 25%) by weight of the shelf stable food. In some embodiments, a shelf stable food can have a sugar content of less than 5% (e.g., less than 3%) by weight of the shelf stable food.

In some embodiments, a shelf stable food provided herein can have a ratio of protein:fat:carbohydrate content that provides about 10% to about 20% of the caloric content of the shelf stable food from protein, about 60% to about 90% of the caloric content of the shelf stable food from fat, and about 5% to about 15% of the caloric content of the shelf stable food from carbohydrate. Such a ratio can be suitable for consumers who follow a diet that induces nutritional ketosis.

A shelf stable food provided herein can have a moisture content of about 3% to about 5%. Surprisingly, a shelf stable food provided herein retains a crunchy texture at a moisture content above 3.5%, and may even be perceived to be crunchier at a moisture content of 4.5%. In contrast, similar foods that have a sugar based binder tend to have a reduced crunchiness at a moisture content above 3.5%, and tend to be perceived as soggy at a moisture content of 4.5%. In some embodiments, a shelf stable food provided herein can have a water activity of less than 0.5 (e.g., less than 0.45).

Also provided herein are methods of making a shelf stable food provided herein. A method of making a shelf stable food includes providing an aggregate phase that includes an aggregate component, as described above, providing a continuous phase component, combining the aggregate component and the continuous phase component to make a formable composition, and baking the formable composition to make the shelf stable food described herein.

In some embodiments, a method can include producing an aggregate phase. In some embodiments, producing an aggregate phase can include combining two or more particulate types (e.g., whole nuts, nut pieces, seeds, seed pieces, dried fruit, protein crisps, and the like) to produce an aggregate component. In some embodiments, producing an aggregate phase can include combining a liquid fat (e.g., an oil or a melted solid fat) with an aggregate component to form the aggregate phase.

A method of making a shelf stable food includes providing a continuous phase component. A “continuous phase component,” as used herein, refers to a liquid that includes dissolved soluble protein in an amount of about 8% to about 30% (e.g., about 10% to about 25%, or about 12% to about 20%) by dry weight of the continuous phase component, and a moisture content of less than 25% (e.g., from about 15% to about 24%, or from about 20% to about 23%). A continuous phase component contributes to a continuous phase of a shelf stable food provided herein once baked. The continuous phase component can include any ingredient appropriate for a continuous phase of a shelf stable food provided herein. In some embodiments, a continuous phase component can comprise an emulsion if a continuous phase is to include a fat.

In some embodiments, a method of making a shelf stable food can include producing a continuous phase component. Generally, a continuous phase component can be produced by producing an aqueous solution containing a soluble protein under conditions sufficient to ensure that the soluble protein is substantially fully dissolved, and other optional ingredients are substantially completely distributed throughout the solution. In some embodiments, an aqueous solution containing a soluble protein can be produced at a temperature of about 40° C. to about 70° C. (e.g., about 45° C. to about 55° C.). In some embodiments, an aqueous solution can also be combined with a fat at or above its melting temperature to produce an emulsion. In some embodiments, a soluble protein can be dissolved in water before combining with a fat to produce a continuous phase component emulsion. In some embodiments, water, soluble protein, and fat can be combined at the same time to produce a continuous phase component emulsion.

In some embodiments, fiber, sugar alcohol, and/or flavorants can be added following dissolution of a soluble protein and/or production of a continuous phase component emulsion. It is preferred that a continuous phase component that contains a sugar alcohol be produced under conditions that limit or prevent dissolution of the sugar alcohol. For example, a sugar alcohol can be included after reducing the temperature of a continuous phase component to a temperature of less than 50° C. to limit dissolution of the sugar alcohol.

In some embodiments, after production of a continuous phase component, the continuous phase component can be allowed to rest for at least 5 minutes (e.g., about 5 minutes up to 2 hours) before being combined with an aggregate phase to produce a formable composition. Generally, allowing a continuous phase component to rest includes providing some time between when all components of the continuous phase component are combined and when the continuous phase component is combined with an aggregate phase. Allowing a continuous phase component to rest can be done during storage the continuous phase component (e.g., with or without agitation) or can be done during other processing steps, such as pumping the continuous phase component from one container to another container.

In some embodiments, a formable composition can be allowed to rest for at least 5 minutes (e.g., about 5 minutes up to 2 hours) before forming. Generally, allowing a formable composition to rest includes providing some time between when all components of the formable composition are combined and when the formable composition is formed. Allowing a formable composition to rest can be done during storage the formable composition (e.g., with or without agitation) or can be done during other processing steps, such as transporting the formable composition. It has been observed that allowing a continuous phase component to rest for at least 5 minutes before using it to produce a formable composition and/or allowing a formable composition to rest at least five minutes can enhance formability of a formable composition, as described in Example 1, below. Allowing a continuous phase component or formable composition to rest can be particularly useful in embodiments where protein content of the continuous phase component is at the lower end of the described range.

A method provided herein includes combining a continuous phase component with an aggregate component to produce a formable composition. In some embodiments, an aggregate component and a continuous phase component can be combined at a ratio by weight of the aggregate component to the continuous phase component of about 50:50 to about 80:20 (e.g., about 60:40 to about 40:60, or about 70:30). In some embodiments, an aggregate component and a continuous phase component can be combined at a ratio by volume of the aggregate component to the continuous phase component of about 50:50 to about 90:10. A moisture content of a continuous phase component of less than 25% (e.g., from about 20% to about 24%, or from about 20% to about 23%) provides an advantage of improving the formability of a formable composition and improving the adhesion of a finished shelf stable food, which enables commercial scale production of the shelf stable food. Without being bound by theory, it is believed that a moisture content of a continuous phase of less than 25% (e.g., from about 20% to about 24%, or from about 20% to about 23%) can ensure sufficient concentration of protein to enable formation of a formable composition and sufficient binding of aggregate components in a finished shelf stable food. Inclusion of a soluble fiber in a continuous phase can also contribute formability of a formable composition.

In embodiments where a permeable or semi-permeable aggregate component is used in an aggregate phase, inclusion of a fat in an aggregate phase can improve formability of a formable composition and can improve the adhesion of a finished shelf stable food, which enables commercial scale production of the shelf stable food. Without being bound by theory, a fat in an aggregate phase is believed to ensure that sufficient continuous phase is available to bind an aggregate phase that includes a permeable or semi-permeable aggregate component together by preventing significant absorption of the continuous phase into the permeable or semi-permeable aggregate component. Inclusion of a soluble fiber in a continuous phase can also reduce absorption of the continuous phase into permeable or semi-permeable aggregate component.

A formable composition is baked to a moisture content of about 3% to about 5% form a shelf stable food described herein. Any suitable method of baking can be used to bake a formable composition. For example, a sheet of formable composition can be baked at a temperature of from about 300° F. to about 400° F. (e.g., about 325° F. to about 375° F.) for about 15 minutes to about 30 minutes (e.g., about 20 minutes to about 25 minutes). It is to be understood that time and temperature suitable for baking a formable composition can be adjusted based on the size, shape, thickness, surface area, ingredient sensitivity to temperature, and the like.

A formable composition can be formed before and/or after baking. For example, a formable composition can be formed into a sheet or slab prior to baking to ensure even baking of the formable composition. In some embodiments, a formable composition can be formed into pieces (e.g., bars, rounds, balls, or the like) prior to baking. In some embodiments, a formable composition can be cut into pieces after baking.

As discussed above, a fat in an aggregate phase can coat permeable or semi-permeable particulates in an aggregate component to improve their texture.

The following examples are provided to show selected embodiments of the invention described herein. The examples are not intended to limit the invention to any particular embodiment.

### EXAMPLES

### Example 1

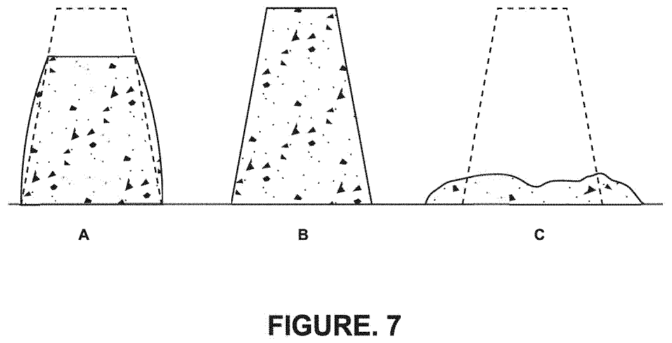

To study the ability of a continuous phase to produce a formable composition when combined with an aggregate phase, and predict the ability of a continuous phase to sufficiently bind aggregate component in a finished shelf stable food, a food slump test was developed. The food slump test used was based on a concrete slump test used to predict workability of concrete. The food slump test was performed as follows. A mold was made from a round, disposable wax coated paper cup (Solo® brand model RW16-00055, Dart Container, Lake Forest, Ill., USA) having a volume capacity of 16 fluid ounces with a height of 5 5/16 inches (13.5 cm), bottom diameter of 2 7/16 inches (6.2 cm), and top diameter of 3½ inches (8.9 cm). The bottom of the cup removed so that both ends were open. The opening in the mold, at the top of the cup, was covered with a removable plastic cover and the mold was filled with formable composition by packing the formable composition without crushing particulates (approximately 370 grams each formable compositions tested at a temperature of about 80° F. to about 95° F.) through the opening of the mold, where the bottom of the cup was removed. The end of the mold with the removable plastic cover was placed on a flat, horizontal, non-porous surface, and the removable plastic cover was slipped out from beneath the mold. Then the mold was immediately and slowly removed by sliding the mold directly upward from the non-porous surface. The formable composition was monitored for 5 minutes, and when a slump was identified (as shown in FIG. 7A, with zero slump shown in FIG. 7B), the time was noted and the slump was measured as the difference between the height of the mold (13.5 cm) and the top of the formable composition. If a formable composition collapsed (as shown in FIG. 7C), the time at which collapse was observed was noted, and the collapse was measured as the difference between the height of the mold (13.5 cm) and the top of the formable composition.

A slump or collapse of 9 cm or less without any rest period for either a continuous phase composition or a formable composition was considered predictive of sufficient formability of the formable composition and sufficient binding activity of the continuous phase for making a suitable shelf stable food at a commercial scale.

Table 1 shows the results of the food slump tests for formable compositions that combine a continuous phase component with an aggregate component. The aggregate component was the same for each sample (mixture of nuts, seeds, and soy protein crisps), except for Sample F (mixture of rolled oats and rice crisps). The continuous phase component and aggregate component for each sample was mixed at about the same ratio on a weight to weight basis (about 30:70 weight to weight continuous phase to aggregate component). The continuous phase component for each sample is as follows:

Sample A: an embodiment of an inventive continuous phase component, including whey protein (15-23% by dry weight), inulin (6-10% by dry weight), erythritol (40-45% by dry weight), coconut oil (15-23% by dry weight), flavorants (6-10% by dry weight), moisture 20-24% by weight

Sample B: an embodiment of an inventive continuous phase component, including whey protein (8-12% by dry weight), inulin (6-11% by dry weight), erythritol (43-51% by dry weight), coconut oil (16-26% by dry weight), flavorants (6-11% by dry weight), moisture 20-24% by weight

Sample C: an embodiment of an inventive continuous phase component, including whey protein (25-30% by dry weight), inulin (5-9% by dry weight), erythritol (35-42% by dry weight), coconut oil (13-21% by dry weight), flavorants (5-9% by dry weight), moisture 20-24% by weight

Sample D: an embodiment of an inventive continuous phase component, including egg white (15-23% by dry weight), inulin (6-10% by dry weight), erythritol (40-45% by dry weight), coconut oil (15-23% by dry weight), flavorants (6-10% by dry weight), moisture 20-24% by weight

Sample E: an embodiment of an inventive continuous phase component, including soluble soy protein isolate (15-23% by dry weight), inulin (6-10% by dry weight), erythritol (40-45% by dry weight), coconut oil (15-23% by dry weight), flavorants (6-10% by dry weight), moisture 20-24% by weight

Sample F: a sugar-based binder from a commercially available crunchy granola bar, including sugar syrups (15-25% by dry weight), vegetable oil (65-75% by dry weight), emulsifier (0.1-1% by dry weight), flavorants (1-6% by dry weight), other ingredients (0.5-1.5%), moisture (22-27%)

TABLE 1

| | Time slump or | | |
|---|---|---|---|
| | collapse noted | | |
| Sample | (in minutes) | Slump after 5 minutes | |
| A | 0:10 collapse | 7 | cm |
| B | 0:17 collapse | 6 | cm |
| C | No slump/collapse | No slump | |
| D | 1:03 collapse | 3.5 | cm |
| E | 5:00 slump | 0.5 | cm |

| | | |
|---|---|---|
| F | 0:05 | 13.5 cm (complete collapse) |

It was observed for Sample A that allowing the continuous phase composition to rest for 30 minutes or 60 minutes before combining with aggregate phase resulted in later and/or less slump or collapse. It was observed for Samples A-E that allowing the formable composition to rest for 30 minutes or 60 minutes before performing the food slump test also resulted in later and/or less slump or collapse.

The implementations described above and other implementations are within the scope of the following claims. One skilled in the art will appreciate that the present disclosure can be practiced with embodiments other than those disclosed. The disclosed embodiments are presented for purposes of illustration and not limitation.

1. A shelf stable food, the shelf stable food comprising:
a. an aggregate phase providing an aggregate component, the aggregate component contributing at least 50% by weight of the shelf stable food, and
b. a continuous phase in an amount of 10% to 50% by weight of the shelf stable food, the continuous having a binding activity that binds the aggregate component together, the continuous phase including a water soluble protein in an amount of from about 8% to about 30% by dry weight of the continuous phase and a soluble fiber in an amount of from about 5% to up to 30% by dry weight of the continuous phase, the water soluble protein contributing substantially all of the binding activity,
wherein the food has a moisture content of about 3% to about 5% and has a crunchy texture upon eating.

2. The shelf stable food of claim 1, wherein the water soluble protein comprises whey protein.

3. The shelf stable food of claim 1, wherein the continuous phase further comprises a sugar alcohol.

4. The shelf stable food of claim 3, wherein the sugar alcohol comprises erythritol.

5. The shelf stable food of claim 1, wherein the soluble fiber is included in an amount of from about 10% to about 25% by dry weight of the continuous phase.

6. The shelf stable food of claim 1, wherein the soluble fiber comprises inulin.

7. The shelf stable food of claim 1, wherein the aggregate component includes permeable or semi-permeable particulates in an amount of from about 15% to about 25% by weight of the aggregate component.

8. The shelf stable food of claim 1, wherein the shelf stable food includes no refined sugar.

9. The shelf stable food of claim 1, wherein the shelf stable food includes less than 5% by total weight sugar.

10. The shelf stable food of claim 1, wherein the shelf stable food includes at least 25% by weight protein.

11. The shelf stable food of claim 1, wherein the shelf stable food has a caloric content that comprises about 10% to about 20% of the caloric content of the shelf stable food from protein, about 60% to about 90% of the caloric content of the shelf stable food from fat, and about 5% to about 15% of the caloric content of the shelf stable food from carbohydrate.

12. The shelf stable food of claim 1, wherein the shelf stable food has a water activity of less than 0.5.

13. A method of making a shelf stable food, comprising:
a. providing an aggregate phase including an aggregate component and a fat;
b. providing a continuous phase component, the continuous phase component comprising an emulsion including dissolved soluble protein in an amount of about 8% to about 30% by dry weight of the continuous phase component, soluble fiber in an amount of about 5% to up to 30% by dry weight of the continuous phase component, fat in an amount of about 15% to about 25% by dry weight of the continuous phase component, and a moisture content of about 15% to less than 25% by weight of the continuous phase;
c. combining the aggregate phase with the continuous phase component to produce a formable composition, the formable composition including the aggregate component and the continuous phase at a ratio by weight of the aggregate component to the continuous phase component of about 50:50 to 80:20; and
d. baking the formable composition to a moisture level of from about 3% to about 5% to make the shelf stable food, the shelf stable food having a crunchy texture and a continuous phase that includes the soluble protein, the continuous having a binding activity that binds the aggregate component together, the water soluble protein contributing substantially all of the binding activity.

14. The method of claim 13, further comprising producing the continuous phase component by combining the protein, the fat, and the water under conditions sufficient to produce the emulsion, and allowing the emulsion to rest for at least 5 minutes before combining with the aggregate phase.

15. The method of claim 13, further comprising producing the aggregate phase by combining the aggregate component with the fat.

16. The method of claim 13, further comprising allowing the formable composition to rest for at least 5 minutes.

17. The method of claim 13, further comprising forming the formable composition into pieces before baking.

18. The method of claim 13, further comprising forming the formable composition into a sheet or slab, and cutting the sheet or slab into pieces after baking.

19. The method of claim 13, wherein the shelf stable food has a caloric content that comprises about 10% to about 20% of the caloric content of the shelf stable food from protein, about 60% to about 90% of the caloric content of the shelf stable food from fat, and about 5% to about 15% of the caloric content of the shelf stable food from carbohydrate.
